(19) United States
(12) Patent Application Publication
(10) Pub. No.: US 2026/0163420 A1
(43) Pub. Date: Jun. 11, 2026

(54) STATOR

(71) Applicants: TOYOTA JIDOSHA KABUSHIKI KAISHA, Toyota-shi (JP); AISIN CORPORATION, Kariya (JP)

(72) Inventors: Shota FUKUNAGA, Toyoake-shi (JP); Takanobu HIRAKAWA, Toyota-shi (JP); Takashi KATO, Kariya-shi (JP); Kei TSUKAMOTO, Kariya-shi (JP); Yuma YAMAUCHI, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/411,511

(22) Filed: Dec. 8, 2025

(30) Foreign Application Priority Data
Dec. 11, 2024 (JP) 2024-216413

(51) Int. Cl. H02K 1/20; H02K 3/34; H02K 9/19; H02K 21/14

(52) U.S. Cl. CPC H02K 1/20; H02K 3/345; H02K 9/19; H02K 21/14

(57) ABSTRACT

A stator includes a stator core and a coil installed in the stator core. The stator core includes a slot extending through the stator core in an axial direction of the stator core and accommodating part of the coil. The slot includes a first section including a first end of the slot in the axial direction, a second section including a second end of the slot in the axial direction, and an intermediate section located between the first and second sections. In the first and second sections, a fixing member is filled between an outer surface of the coil and an inner surface of the slot. In the intermediate section, no fixing member is present between the outer surface of the coil and the inner surface of the slot. The stator core includes a flow path that provides communication between the intermediate section and the outside of the stator core.

### CROSS-REFERENCE TO RELATED APPLICATION

This application claims priority to Japanese Patent Application No. 2024-216413 filed on Dec. 11, 2024. The disclosure of the above-identified application, including the specification, drawings, and claims, is incorporated by reference herein in its entirety.

### BACKGROUND

### 1. Technical Field

The technique disclosed in the present specification relates to stators for electric motors.

### 2. Description of Related Art

A stator disclosed in Japanese Unexamined Patent Application Publication No. 2018-078764 (JP 2018-078764 A) includes a stator core extending in a cylindrical shape along an axial direction of the stator, and rectangular wires (coil) installed in slots of the stator core. An insulating paper having a plurality of recesses extending along the axial direction is disposed between an inner surface of each slot and the rectangular wires. A cooling medium circulates through the recesses of the insulating paper to cool the rectangular wires.

### SUMMARY

When electric power is supplied to the rectangular wires, the rectangular wires generate heat. In the stator disclosed in JP 2018-078764 A, the slots of the stator core are open at both axial ends. Therefore, at both axial ends of the slots, heat generated by the rectangular wires is easily dissipated to the outside of the stator core. However, in this stator, the rectangular wires are arranged in the rectangular slots with little or no gap, and heat generated in intermediate sections of the slots in the axial direction may stay in the slots without being dissipated to the outside of the stator core. In such a case, the intermediate sections of the slots may reach a high temperature. The present specification provides a technique for suppressing an increase in temperature in an intermediate section of a slot.

The technique disclosed in the present specification is embodied in a stator of an electric motor. The stator includes a stator core and a coil installed in the stator core. The stator core includes a slot. The slot extends through the stator core in an axial direction of the stator core and accommodates part of the coil. The slot includes a first section including a first end of the slot in the axial direction, a second section including a second end of the slot in the axial direction, and an intermediate section located between the first section and the second section. In the first section and the second section, a fixing member is filled between an outer surface of the coil and an inner surface of the slot. In the intermediate section, the fixing member is not present between the outer surface of the coil and the inner surface of the slot. The stator core includes a flow path configured to provide communication between the intermediate section and outside of the stator core.

In the above configuration, in the intermediate section, the fixing member is not present between the outer surface of the coil and the inner surface of the slot. Therefore, in the intermediate section, there is a space between the outer surface of the coil and the inner surface of the slot. Furthermore, since the intermediate section communicates with the outside of the stator core via the flow path, heat that accumulates in the intermediate section can be dissipated to the outside of the stator core via the flow path. Accordingly, the intermediate section of the slot is less likely to reach a high temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial cross-sectional view of an electric motor 10 including a stator 20 according to an embodiment; and

FIG. 2 is a sectional view taken along line II-II in FIG. 1.

### DETAILED DESCRIPTION OF EMBODIMENTS

In one embodiment of the present technique, the coil may include a first coil segment protruding from the first end of the slot, a second coil segment protruding from the second end of the slot, and a connecting member configured to electrically connect the first coil segment and the second coil segment. In this case, the connecting member may be disposed in the intermediate section of the slot.

The region around the connecting member that electrically connects the first coil segment and the second coil segment has higher electrical resistance than general portions of the coil segments. As a result, the amount of heat generated in the region around the connecting member increases, making the region more likely to reach a high temperature. With this configuration, since the connecting member is disposed in the intermediate section, heat around the connecting member can be dissipated to the outside of the stator core via the flow path.

In one embodiment of the present technique, the connecting member may be constituted by a tubular member that accommodates an end of the first coil segment and an end of the second coil segment.

With this configuration, since the tubular member that accommodates the ends of the coil segments is used, the coil segments can be electrically connected using a relatively simple structure.

In one embodiment of the present technique, the stator may further include an insulating paper disposed in the slot and extending from the first section through the intermediate section to the second section. In this case, in the first section and the second section, the fixing member may be constituted by a foamed resin applied to the insulating paper. In the intermediate section, the insulating paper may not be coated with the foamed resin.

With this configuration, for example, by applying the foamed resin to portions of a single sheet of insulating paper corresponding to the first and second sections, and not applying the foamed resin to a portion of the sheet of insulating paper corresponding to the intermediate section, the intermediate section free from the fixing member can be formed relatively easily.

In one embodiment of the present technique, the stator core may include: a plurality of slots including the slot and arranged along a circumferential direction of the stator core; and a plurality of flow paths including the flow path and each provided for a corresponding one of the slots. In this case, each of the flow paths may include: a main flow section that extends through the stator core in the axial direction; and a branch flow section that branches off from the main flow section and is connected to the intermediate section of the corresponding one of the slots. The main flow section of each of the flow paths may be adjacent to the corresponding one of the slots from the outer side in a radial direction of the stator core. The branch flow section of each of the flow paths may be in communication with the intermediate section of the corresponding one of the slots.

With this configuration, the entire slot can be cooled by the main flow section extending parallel to the slot in the axial direction. In addition, since the intermediate section and the branch flow section are connected, heat released from the intermediate section can be dissipated to the outside of the stator core via the branch flow section and the main flow section. Furthermore, since the main flow section is adjacent to the slot from the outer side in the radial direction, the magnetic flux density generated in the stator core can be increased compared to, for example, a configuration in which the main flow section is adjacent to the slot in the circumferential direction of the stator core.

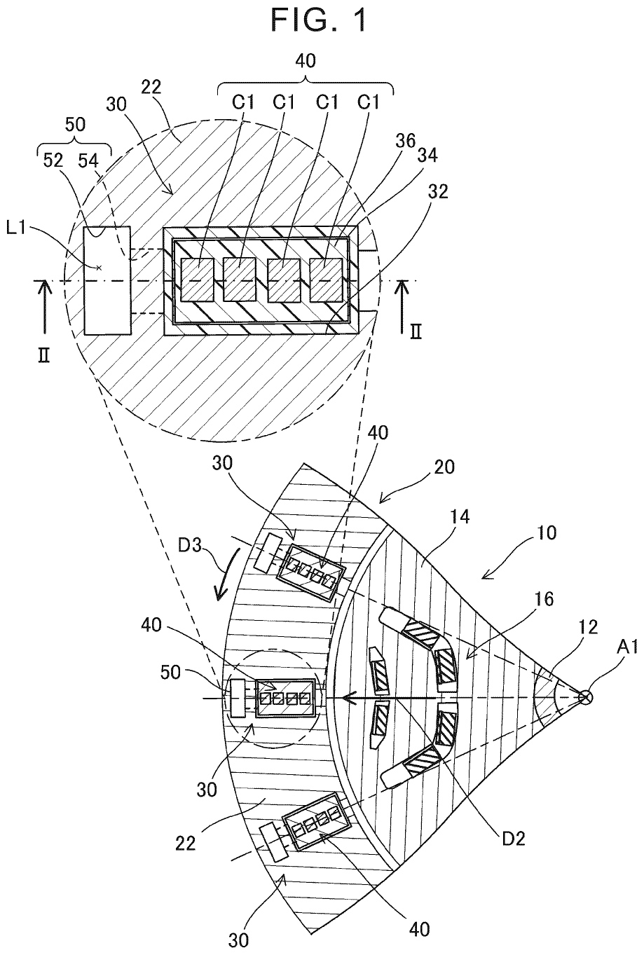

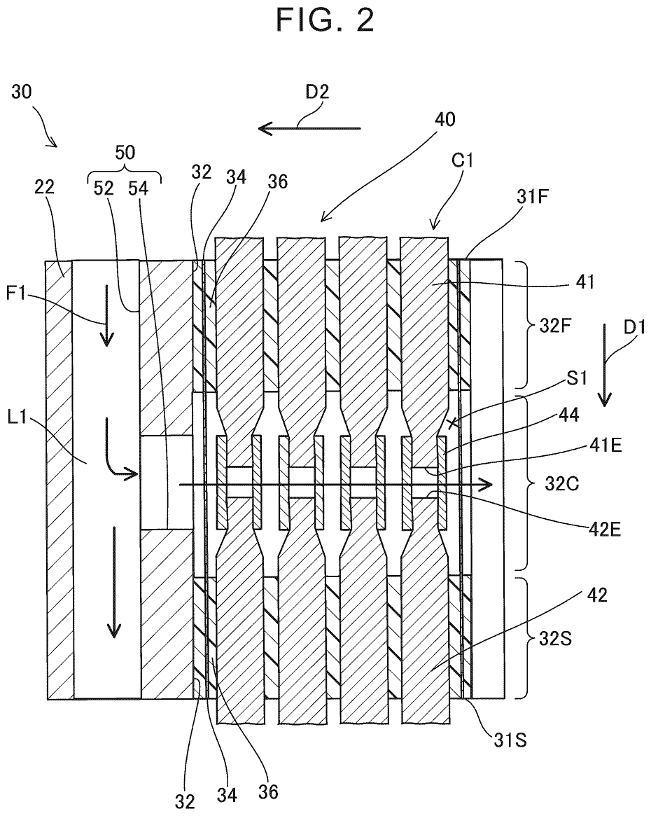

FIG. 1 is a partial cross-sectional view of an electric motor 10 including a stator 20 according to an embodiment. The electric motor 10 is employed, for example, as a prime mover for driving wheels of an electrified vehicle. Examples of the electrified vehicle include a battery electrified vehicle, a hybrid electrified vehicle, a plug-in hybrid electrified vehicle, and a fuel cell electrified vehicle. In the following description, a direction along a central axis A1 of the electric motor 10 (i.e., the front-back direction in the plane of FIG. 1) may be referred to as axial direction D1 (see FIG. 2). Similarly, a direction extending from the central axis A1 of the electric motor 10 toward the outer periphery thereof may be referred to as radial direction D2, and a direction along the outer periphery of the electric motor 10 may be referred to as a circumferential direction D3 FIG. 1 is a partial cross-sectional view of the electric motor 10 taken along a plane perpendicular to the axial direction D1. Regarding the radial direction D2, the direction toward the outer periphery (i.e., the direction indicated by arrow D2) may be referred to as the “outer side” in the radial direction D2, and the opposite direction may be referred to as the “inner side” in the radial direction D2.

As shown in FIG. 1, the electric motor 10 includes, in addition to the stator 20, a shaft 12, a rotor 14, and a coil 40. The shaft 12 extends along the central axis A1 and supports the rotor 14. The rotor 14 is located on the inner side in the radial direction D2 of the stator 20 and rotates about the shaft 12. The rotor 14 is made of a soft magnetic material. As an example, the rotor 14 of the present embodiment has a laminated structure of electrical steel sheets. A plurality of permanent magnets 16 is disposed in the rotor 14 along the circumferential direction D3.

The stator 20 includes a stator core 22. The stator core 22 is made of a soft magnetic material. As an example, the stator core 22 of the present embodiment has a laminated structure of a plurality of electrical steel sheets (not shown). The stator core 22 extends in a cylindrical shape along the axial direction D1. That is, the axial direction D1 corresponds to the axial direction of the stator core 22. In the stator core 22, a plurality of coil fixing portions 30 for installing the coil 40 in the stator core 22 is arranged at predetermined intervals along the circumferential direction D3. The coil fixing portions 30 each have the same configuration.

The coil fixing portions 30 will be described in detail with reference to the enlarged view shown in the upper part of FIG. 1 and FIG. 2. The coil fixing portion 30 includes a slot 32, an insulating paper 34, a foamed resin 36, and a flow path 50. As shown in FIG. 2, the slot 32 is a space extending through the stator core 22 in the axial direction D1. The coil 40 passes through the slot 32 and extends along the axial direction D1. That is, the slot 32 houses part of the coil 40.

The slot 32 extends along the axial direction D1 from a first end 31F to a second end 31S. The slot 32 includes a first section 32F including the first end 31F, a second section 32S including the second end 31S, and an intermediate section 32C located between the sections 32F, 32S.

Three-phase alternating current power is supplied to the coil 40 from an inverter (not shown) disposed outside the electric motor 10. As a result, magnetic force is generated between the stator 20 and the rotor 14, causing the rotor 14 to rotate. The coil 40 is formed by a plurality of coil wires C1 arranged along the radial direction D2. Each of the coil wires C1 includes a first coil segment 41 protruding from the first end 31F of the slot 32, a second coil segment 42 protruding from the second end 31S, and a tubular member 44 connecting the coil segments 41, 42. In FIG. 2, reference signs are provided only for the coil wire C1 located at the innermost side of the stator core 22 in the radial direction D2 (i.e., the right side in FIG. 2), and reference signs for the other coil wires C1 are omitted.

The tubular member 44 is a tubular member made of an electrically conductive metal (e.g., copper). The tubular member 44 accommodates a first coil end 41E of the first coil segment 41 and a second coil end 42E of the second coil segment 42. As shown in FIG. 2, the coil ends 41E, 42E are not in contact with each other. However, the coil ends 41E, 42E are electrically connected via the tubular member 44. In other words, the tubular member 44 serves as a connection member that electrically connects the coil segments 41, 42. By electrically connecting the coil segments 41, 42 via the tubular member 44, the coil segments 41, 42 can be connected using a relatively simple structure.

As shown in FIG. 2, the cross-sectional area of the first coil end 41E is smaller than that of the remaining portion of the first coil segment 41. Similarly, the cross-sectional area of the second coil end 42E is smaller than that of the remaining portion of the second coil segment 42. The tubular member 44 accommodates the coil ends 41E, 42E each having a reduced cross-sectional area. The outer diameter of the tubular member 44 can thus be reduced. Accordingly, the size of the slot 32 can be reduced particularly in the radial direction D2, and the size of the electric motor 10 can also be reduced.

The insulating paper 34 is disposed on the inner surface of the slot 32. The insulating paper 34 ensures electrical insulation between the stator core 22 and the coil wires C1. In the present embodiment, the insulating paper 34 is configured as a single sheet of material having electrically insulating properties and extending from the first section 32F through the intermediate section 32C to the second section 32S. The insulating paper 34 is, for example, a polyester film, an aramid film, a polyethylene terephthalate film, a polyethylene naphthalate film, or kraft paper.

The foamed resin 36 is provided on the insulating paper 34. The foamed resin 36 is made of foamable resin that foams upon heating. The foamed resin 36 is formed on both surfaces of the insulating paper 34. In the manufacturing process of the stator 20, the insulating paper 34 coated with the foamed resin 36 is placed on the inner surface of the slot 32 of the stator core 22. In this state, the first coil segments 41 of the coil wires C1 and the tubular members 44 are inserted into the slot 32 from the first end 31F of the slot 32, and then the second coil segments 42 are inserted into the slot 32 from the second end 31S. The coil segments 41, 42 are thus connected via the tubular members 44. Subsequently, the stator core 22 and the coil wires C1 are heated, causing the foamed resin 36 to expand through foaming, thereby filling the gap between the inner surface of the slot 32 and the outer surfaces of the coil wires C1 as well as the gaps between adjacent coil wires C1. As a result, the coil wires C1 of the coil 40 are fixed in the slot 32. In other words, the foamed resin 36 serves as a fixing member that secures the coil 40 in the slot 32.

As shown in FIG. 2, in the first section 32F of the slot 32, the foamed resin 36 is filled between the surface of the insulating paper 34 and the outer surfaces of the first coil segments 41 of the coil 40. Similarly, in the second section 32S, the foamed resin 36 is filled between the surface of the insulating paper 34 and the outer surfaces of the second coil segments 42. However, in the intermediate section 32C, the foamed resin 36 is not present between the surface of the insulating paper 34 and the outer surfaces of the coil segments 41, 42. That is, in the intermediate section 32C, a space S1 is present between the inner surface of the slot 32 and the outer surfaces of the coil segments 41, 42.

In the manufacturing process of the stator 20, the insulating paper 34 described below is used. A portion of the insulating paper 34 that is to be located in the intermediate section 32C is not coated with the foamable resin. On the other hand, portions of the insulating paper 34 that are to be located in the first section 32F and the second section 32S are coated with the foamable resin. In this way, by not applying the foamable resin to the portion of the single sheet of insulating paper 34 that is to be located in the intermediate section 32C, the intermediate section 32C free from the foamed resin 36 can be easily formed.

As described above, three-phase alternating current power is supplied from the inverter (not shown) to the coil 40 to cause the rotor 14 to rotate. Since this three-phase alternating current power has a high voltage, the coil 40 generates a relatively large amount of heat when the three-phase alternating current power is supplied to the coil 40. Accordingly, the stator 20 is provided with the flow path 50.

The flow path 50 is adjacent to the slot 32 from the outer side in the radial direction D2. The flow path 50 includes a main flow section 52 that extends through the stator core 22 along the axial direction D1 of the stator core 22, and a branch flow section 54 that branches off from the main flow section 52 and extends toward the inner side in the radial direction D2. The flow path 50 is a space formed inside the stator core 22. Both ends of the main flow section 52 of the flow path 50 in the axial direction D1 are open to the outside of the stator core 22. The branch flow section 54 of the flow path 50 connects the main flow section 52 of the flow path 50 with the intermediate section 32C of the slot 32. That is, the flow path 50 provides communication between the space S1 in the intermediate section 32C and the outside of the stator core 22.

The main flow section 52 of the flow path 50 is adjacent to the slot 32 from the outer side in the radial direction D2. Accordingly, compared to a configuration in which the main flow section 52 is adjacent to the slot 32 in the circumferential direction D3, the magnetic flux density generated when the three-phase alternating current power is supplied to the coil 40 is less likely to be blocked by the slot 32. As a result, the magnetic flux density generated in the stator core 22 increases, thereby improving the output of the electric motor 10.

The flow path 50 is filled with oil L1. As indicated by arrow F1 in FIG. 2, the oil L1 flows into the main flow section 52 of the flow path 50 from an end adjacent to the first end 31F of the slot 32, passes through the space S1 in the intermediate section 32C, and flows out from an end adjacent to the second end 31S of the slot 32. That is, the flow path 50 circulates the oil L1. The oil L1 is, for example, a cooling oil such as Automatic Transmission Fluid (ATF) (registered trademark). The sections 32F, 32S of the slot 32 can be cooled as the oil L1 circulates through the main flow section 52 of the flow path 50 that extends parallel to the sections 32F, 32S in the axial direction D1. In addition, the intermediate section 32C of the slot 32 can be cooled as the oil L1 is supplied to the intermediate section 32C via the branch flow section 54 of the slot 32.

### Effects of Present Embodiment

In the stator 20 of the present embodiment, the foamed resin 36 is not present in the intermediate section 32C of the slot 32. Therefore, the space S1 is present between the surface of the insulating paper 34 and a portion of the outer surface of each coil segment 41, 42. In addition, since the space S1 in the intermediate section 32C communicates with the outside of the stator core 22 via the flow path 50, heat that accumulates in the space S1 of the intermediate section 32C can be dissipated to the outside of the stator core 22 via the flow path 50 and the oil L1 circulating through the flow path 50. Accordingly, the intermediate section 32C of the slot 32 is less likely to reach a high temperature.

Furthermore, in the stator 20 of the present embodiment, the tubular members 44 each connecting the coil segments 41, 42 of a corresponding one of the coil wires C1 are disposed in the intermediate section 32C. The region around the tubular members 44 that connects the coil segments 41, 42 has higher electrical resistance than the general portions of the coil segments 41, 42. Moreover, as described above, the cross-sectional area of the coil ends 41E, 42E of the coil segments 41, 42 is smaller than that of the general portions of the coil segments 41, 42. Therefore, since the electrical resistance is higher at the coil ends 41E, 42E, the intermediate section 32C in which the tubular members 44 are disposed tend to reach a high temperature. The stator 20 of the present embodiment allows heat from the intermediate section 32C in which the tubular members 44 are disposed to be dissipated to the outside of the stator core 22 through the flow path 50.

Although specific examples of the technology disclosed in the present specification have been described in detail, these examples are merely illustrative and are not intended to limit the scope of the claims. The scope of the claims encompasses various modifications and changes to the illustrated embodiment. Modifications of the above embodiment are listed below.

### First Modification

The tubular members 44 may not be disposed in the intermediate section 32C of the slot 32. The tubular members 44 may be disposed in, for example, the first section 32F. In another modification, each of the coil wires C1 of the coil 40 may be configured without the tubular member 44, and may instead be configured as a single coil segment.

### Second Modification

The coil segments 41, 42 of each coil wire C1 of the coil 40 may not be connected via the tubular member 44. For example, the coil segments 41, 42 may be connected by welding. In this modification, a welding member that welds the coil segments 41, 42 is one example of the “connecting member.”

### Third Modification

The coil segments 41, 42 of the coil 40 may not be fixed to the slot 32 by the foamed resin 36. For example, the coil segments 41, 42 may be fixed to the slot 32 by varnish. In this modification, the varnish is one example of the “fixing member.”

### Fourth Modification

The main flow section 52 of the flow path 50 may be disposed adjacent to the slot 32 in the circumferential direction D3.

### Fifth Modification

In the above embodiment, one flow path 50 is provided for each slot 32. In this modification, for example, one flow path 50 may be connected to the intermediate sections 32C in a plurality of slots 32. In such a case, the flow path 50 may include one main flow section 52 and a plurality of branch flow sections 54 that branches off from the main flow section 52.

### Sixth Modification

The oil L1 may not circulate through the flow path 50. For example, air or another fluid may circulate through the flow path 50.

The technical elements illustrated in the present specification or the drawings exhibit technical utility alone or in various combinations, and are not limited to the combinations set forth in the claims as originally filed. The techniques illustrated in the present specification or the drawings may achieve a plurality of objectives at the same time, and achieving even one of the objectives alone provides technical utility.

What is claimed is:

1. A stator for an electric motor, the stator comprising:
a stator core; and
a coil installed in the stator core, wherein:
the stator core includes a slot, the slot extending through the stator core in an axial direction of the stator core and accommodating part of the coil;
the slot includes
a first section including a first end of the slot in the axial direction,
a second section including a second end of the slot in the axial direction, and
an intermediate section located between the first section and the second section;
in the first section and the second section, a fixing member is filled between an outer surface of the coil and an inner surface of the slot;
in the intermediate section, the fixing member is not present between the outer surface of the coil and the inner surface of the slot; and
the stator core includes a flow path configured to provide communication between the intermediate section and outside of the stator core.

2. The stator according to claim 1, wherein:
the coil includes
a first coil segment protruding from the first end of the slot,
a second coil segment protruding from the second end of the slot, and
a connecting member configured to electrically connect the first coil segment and the second coil segment; and
the connecting member is disposed in the intermediate section of the slot.

3. The stator according to claim 2, wherein the connecting member is constituted by a tubular member that accommodates an end of the first coil segment and an end of the second coil segment.

4. The stator according to claim 1, further comprising an insulating paper disposed in the slot and extending from the first section through the intermediate section to the second section, wherein:
in the first section and the second section, the fixing member is constituted by a foamed resin applied to the insulating paper; and
in the intermediate section, the insulating paper is not coated with the foamed resin.

5. The stator according to claim 1, wherein:
the stator core includes
a plurality of slots including the slot and arranged along a circumferential direction of the stator core, and
a plurality of flow paths including the flow path and each provided for a corresponding one of the slots;
each of the flow paths includes
a main flow section that extends through the stator core in the axial direction, and
a branch flow section that branches off from the main flow section and is connected to the intermediate section of the corresponding one of the slots;
the main flow section of each of the flow paths is adjacent to the corresponding one of the slots from an outer side in a radial direction of the stator core; and
the branch flow section of each of the flow paths is in communication with the intermediate section of the corresponding one of the slots.
